(19) United States
(12) Patent Application Publication
(10) Pub. No.: US 2007/0080101 A1
(43) Pub. Date: Apr. 12, 2007

(54) Isotonic ozone water generator

(76) Inventor: Yuan-Liang Huang, Hsinchu City (TW)

Correspondence Address: RABIN & BERDO, P.C., Suite 500, 1101 14 Street, N.W., Washington, DC, 20005, US

(21) Appl. No.: 11/246,176

(22) Filed: Oct. 11, 2005

(51) Int. Cl. C02F 1/78

(52) U.S. Cl. 210/198.1

(57) ABSTRACT

An isotonic Ozone generator is disclosed. A supplementary liquid reservoir with pipeline is connected to the outlet of water-gas mixer with 3-way adapter and a flow meter pump at lower position. The hypertonic solution is accommodated in the liquid reservoir. With precise control of flow meter pump, the hypertonic solution from liquid reservoir is mixing with concentrated Ozone water from water-gas mixer at constant rate and ratio to form ISOTONIC OZONE WATER for directly applying onto internal or external wounds of human bodies for disinfection.

### BACKGROUND OF THE INVENTION

(a) Field of the Invention

The present invention relates to an isotonic Ozone water generator, especially refer to an Ozone water generator being directly applied onto internal or external wounds of human bodies for disinfection. The medical grade high concentrate Saline Solution flows through the rear end of device water outlet, then, mixed up with Ozone water at a constant ratio to generate isotonic Ozone water for wounds disinfection.

(b) Description of the Prior Art

Traditionally, Ozone water is made of water (H2O) and Ozone (O3) gas, which generated either via Electrolysis or Electrical Shock; is a kind of low osmotic pressure solution, such as pure water. The normal osmotic pressure of human blood ranges from 270 to 300 mosm /l. Thus, when the hypotonic Ozone water being applied onto the external or internal wounds of human, the Ozone water will penetrate into the cells under equilibrium dynamic reaction. This resulted in higher volume of water retains in the cell leading to swollen wounds and severe pain for the nerves pressed by the swollen cells. Even though Ozone water is a well-known high efficient sterilization solution, it is hardly to be applied in medical clinics for wounds disinfection, especially for the wounds with nerves clustered, say, Cavity or Bedsore at around low back area. Due to severe pain may associate with this kind of treatment for nerves pressed by swollen cells. This has dramatically reduced the value of Ozone water application in clinical wounds disinfection and its economical value. Therefore, further improvement to eliminate the disadvantages of this type Ozone water is needed.

Hence, it is a primary objective of the present invention in providing an isotonic Ozone water generator to generate Ozone water with identical or closing osmotic pressure with human blood, 250˜320 mosm /l, so as to be applied in medical clinics for external or internal wounds disinfection.

### SUMMARY OF THE INVENTION

In order to achieve above objective set forth, an isotonic Ozone water generator in accordance with the present invention is consisting of a Cathode water tank, electrolysis Ozone generator and a water-gas mixer etc. When system on, water (pure water) in Cathode water tank is filled into electrolysis Ozone generator through two water inlets located at the bottom of electrolysis Ozone generator. After electrolysis, Cathode generates Hydrogen gas flows back into Cathode water tank via outlet connecting duct at Cathode; Anode generates Ozone gas directly flows into water-gas mixer via separated outlet connecting duct at Anode for being mixed with water to form high-concentrated Ozone water that is being exhausted through an outlet at the bottom of water-gas mixer for apply. The unique features of the present invention are:

A supplementary liquid reservoir with pipeline is connected to the outlet of water-gas mixer with 3-way adapter and a flow meter pump at lower position. The hypertonic solution such as medical grade Normal Saline or Glucose solution is accommodated in the liquid reservoir. With precise control of flow meter pump, the hypertonic solution from liquid reservoir is mixing with concentrated Ozone water from water-gas mixer at constant rate and ratio to form ISOTONIC OZONE WATER.

As above stated, the present invention is to specially design a supplementary liquid reservoir of medical grade Normal Saline solution, connecting with 3-way adapter and flow meter pump to consistently control the flow amount and ratio between concentrated Ozone water and hypertonic solution, so as to increase and control osmotic pressure of Ozone water in 250˜320 mosm/l range. This Ozone water osmotic pressure is very closing to human blood can be directly applied onto internal or external wounds of human bodies for disinfection once generate.

### BRIEF DESCRIPTION OF THE DRAWINGS

The structure and operational mechanism adopted by the present invention to achieve the above and other objectives can be better understood by referring to the following detailed description of the preferred embodiments and the accompanying drawings, wherein

FIG. 1 is a schematic drawing of an embodiment in accordance with the present invention.

### DETAILED DESCRIPTION OF THE PREFERRED EMBODIMENT

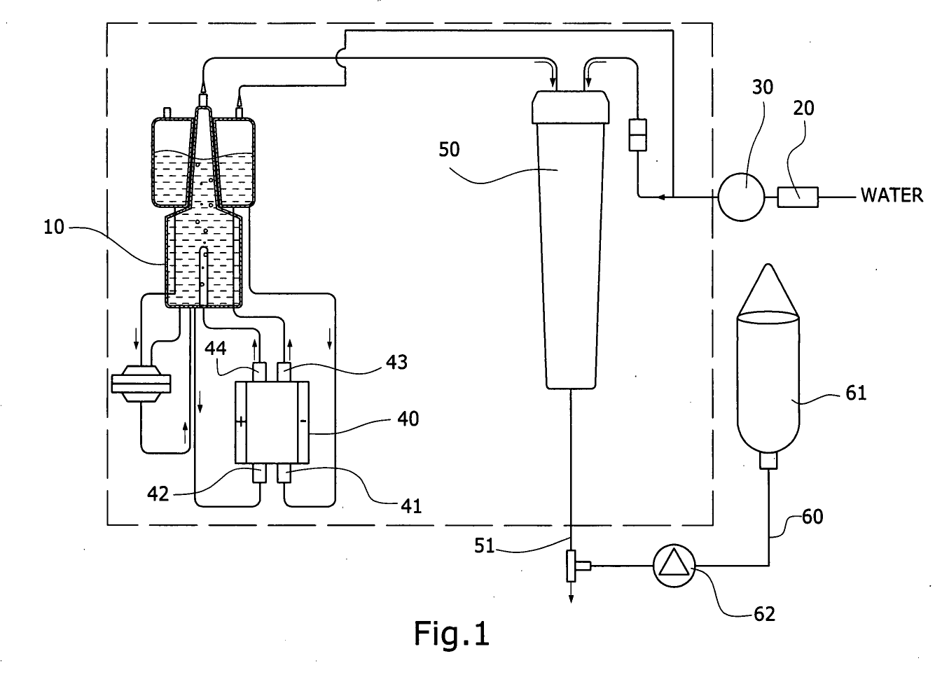

Refer to FIG. 1; an isotonic Ozone water generator in accordance with the present invention consists of a Cathode water tank 10; a filter 20 a pump 30; an electrolysis Ozone generator 40 and a water-gas mixer 50. When system on, water (or pure water) in Cathode water tank 10 is filled into electrolysis ozone generator 40 through two water inlets 41, 42 located at the bottom of electrolysis ozone generator 40. When water is electrolyzed, Cathode generates Hydrogen gas flows back into Cathode water tank 10 via outlet 43 connecting duct at Cathode; Anode generates Ozone gas directly flows into water-gas mixer 50 via separated outlet 44 connecting duct at Anode for being mixed with water to form high-concentrated Ozone water that is being exhausted through an outlet 51 at the bottom of water-gas mixer 50 for apply. The present invention is characterized in that:

A supplementary liquid reservoir 61 with pipeline 60 is connected to the outlet 51 of water-gas mixer 50 with 3-way adapter and a flow meter pump 62 at lower position. The hypertonic solution (in this embodiment is medical grade Normal Saline) is accommodated in the liquid reservoir 61. With precise control of flow meter pump 62. The hypertonic solution from liquid reservoir 61 is mixing with concentrated Ozone water from water-gas mixer 50 at constant rate and ratio to form ISOTONIC OZONE WATER.

In accordance with the above description, medical grade Normal Saline in supplementary liquid reservoir 61 flows through reservoir pipeline 60, is controlled and adjusted by the flow meter pump 62, so as to mix with concentrated Ozone water from water-gas mixer 50 at consistent volume and ratio. Thus, the osmotic pressure of Ozone water is increased and controlled at the range of 250˜320 mosm/l. Therefore, the isotonic Ozone water can be directly applied onto internal or external wounds of human bodies for disinfection.

In summary, an isotonic Ozone generator in accordance with the present invention can prevent from swollen wound (caused by a large amount of water molecule penetrate into wound cells under equilibrium dynamic effect of osmotic pressure) while direct applying generated isotonic Ozone water onto internal or external wounds of human bodies for disinfection.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An isotonic Ozone water generator in accordance with the present invention is consisting of a Cathode water tank, electrolysis Ozone generator and a water-gas mixer etc.
Wherein two inlets of the electrolysis Ozone generator are connected to the Cathode water tank while one outlet on a Cathode end of the electrolysis Ozone generator is connected to the Cathode water thank, and another outlet on an Anode end of the electrolysis Ozone generator is connected to the water-gas mixer that having an outlet on lower end for supplying Ozone water; the isotonic Ozone water generator is characterized in that:
A supplementary liquid reservoir with pipeline is connected to the outlet of water-gas mixer with 3-way adapter and a flow meter pump at lower position. The hypertonic solution is accommodated in the liquid reservoir. With precise control of flow meter pump, the hypertonic solution from liquid reservoir is mixing with concentrated Ozone water from water-gas mixer at constant rate and ratio to form ISOTONIC OZONE WATER.
